(19) United States
(12) Patent Application Publication
(10) Pub. No.: US 2010/0017523 A1
(43) Pub. Date: Jan. 21, 2010

(54) COMMUNICATION CONTROL APPARATUS AND COMMUNICATION CONTROL METHOD

(75) Inventor: Hideya YOSHIUCHI, Beijing (CN)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/501,002

(22) Filed: Jul. 10, 2009

(30) Foreign Application Priority Data
Jul. 15, 2008 (CN) 200810133925.8

(51) Int. Cl. G06F 15/16

(52) U.S. Cl. 709/228

(57) ABSTRACT

A data transmission control server is connected to a network, and communicates with a data transmission server, a data transmission auxiliary server, and a client via the network. The data transmission server and the data transmission auxiliary server respectively include: a network interface that transmits data to the client based on a client request; a data transmission information database having stored therein a data identifier for identifying transmission data, a data transmission address for specifying an address of the transmission data, and a data transmission beginning time indicative of a beginning time of data transmission; and a control unit that controls the data transmission server and the data transmission auxiliary server so as to transmit data to the client by transmitting transmission data session information to the data transmission server and the data transmission auxiliary server b a data transmission request from the client.

### INCORPORATION BY REFERENCE

The present application claims priority from Chinese application CN P200810133925.8 filed on Jul. 15, 2008, the content of which is hereby incorporated by reference into this application.

### BACKGROUND OF THE INVENTION

The present invention relates to communication control apparatuses and communication control methods, and in particular relates to a data transmission control server and data transmission system capable of reducing the load on a server that transmits data to multiple users.

Most of communications, such as video on demand (VoD) and download of an incoming mail, are performed by unicast. Since the unicast secures a single communication path between both parties that communicate with each other, the unicast consumes communication bandwidths corresponding to the number of users when a plurality of users request for download of the same data. Multicast is broadcast communication to a group and aims at sharing a bandwidth among a plurality of users. However, the multicast cannot respond to a single data download by a user, such as the above-described VoD.

In order to efficiently perform data transmission on a plurality of users, a known technique in “JP-A-2001-344166” discloses, for example, a method in which the transmission times of contents and transmission apparatuses are sequentially scheduled based on user requests. This well-known example publicizes a technique, wherein when data transmission requests from a plurality of users arrive within a certain time, multicast data transmission is performed with these transmission requests put together.

The techniques for transmitting data without a loss of data by using multicast include a reliable multicast technique. As with Transmission Control Protocol (TCP) in unicast, this reliable multicast technique is intended for a data sender to perform a retransmission processing based on a request from a data recipient and thereby reliably transmit data when a loss of data occurred.

### SUMMARY OF THE INVENTION

As the network bandwidth available to a user continues to increase, it is theoretically possible to transmit large amounts of data reaching several Gigabytes (GB) by using the reliable multicast technique. However, in transmission of large amounts of data, even without taking into account a retransmission processing, a considerable amount of time is required only for transmission from beginning to end, and furthermore, due to the retransmission processing of data, time required for data transmission becomes longer. For example, if it takes 30 minutes to transmit certain data from beginning to end, the time required for all the data recipients to actually finish data reception will be this 30 minutes plus a time (e.g., 10 minutes) required for the retransmission processing. The time required for a retransmission processing varies with the conditions of a network and a data recipient. On the other hand, in such a high capacity data transmission server, scheduling of data transmission is required from a view point of resource management of the data transmission server. However, as described above, since the time required for the data retransmission processing dynamically varies, it is difficult to determine a transmission schedule.

The present invention relates to a technique for distributing the load on an apparatus that transmits data to a plurality of users. It is an object of the present invention to provide a communication control apparatus and a communication control method, wherein in transmitting large amounts of data by multicast communication, the load is distributed between a data transmission server that transmits (broadcasts) data only once by multicast and a data transmission auxiliary server that performs a retransmission processing on auxiliary data, so that a data retransmission processing does not affect the scheduling of data transmission. On the other hand, in the above-described communication control apparatus and communication control method, usually, the transmission of data is performed only once to correspond to the broadcasting of data, so the server for transmitting data is referred to as the data transmission server while the data transmission auxiliary server is referred to as a data retransmission server hereinafter because the role of the data transmission auxiliary server is mainly the retransmission of data.

In order to achieve the above-described object, a data transmission control server according to the present invention is connected to a network and communicates with a data transmission server, a data transmission auxiliary server, and a client via the network, wherein the data transmission server and the data transmission auxiliary server respectively include: a network interface that transmits data to the client based on a client request; and a control unit with a data transmission information database having stored therein a data identifier for identifying transmission data, a data transmission address for specifying an address of the transmission data, and a data transmission beginning time indicative of a beginning time of data transmission, wherein the control unit controls the data transmission server and the data transmission auxiliary server so as to transmit data to the client by transmitting transmission data session information to the data transmission server and the data transmission auxiliary server based on a data transmission request from the client.

The data transmission auxiliary server, when there is a loss in received data of the client, retransmits data to the client based on a retransmission request from the client.

The retransmission request from the client is directly transmitted to the data transmission auxiliary server, or is transmitted to the data transmission auxiliary server via the data transmission control server or the data transmission server.

The data transmission auxiliary server according to the present invention includes: a network interface connected to a network, the network interface communicating via the network with a client having requested for data transmission, a data transmission control server that controls a data transmission processing, and a data transmission server that transmits data at a predetermined time; a data information database having stored therein transmission data including a data identifier for identifying the transmission data and a set of data blocks determined by a unique number; a data transmission information database having stored therein a data identifier for identifying transmission data, a data transmission address for specifying an address of the transmission data, a data transmission beginning time indicative of a beginning time of data transmission, and a data requester address for managing an address of a client having requested for data transmission; and a control unit that receives transmission data session information from the data transmission control server, and retransmits data to the client when there is a loss in data received from the server and the client transmits a retransmission request.

A data transmission system according to the present invention includes a client, and a data transmission control server, a data transmission server, and a data transmission auxiliary server that are connected to the client via a network, wherein the data transmission server and the data transmission auxiliary server transmit data to the client under control of the data transmission control server, wherein the data transmission control server is connected to the network and communicates with the data transmission server, the data transmission auxiliary server, and the client via the network, wherein the data transmission server and the data transmission auxiliary server respectively include: a network interface that transmits data to the client based on a client request; and a control unit with a data transmission information database having stored therein a data identifier for identifying transmission data, a data transmission address for specifying an address of the transmission data, and a data transmission beginning time indicative of a beginning time of data transmission, and wherein by transmitting transmission data session information based on a data transmission request from the client, the control unit controls the data transmission server and the data transmission auxiliary server so as to transmit the data to the client.

In the present invention, the retransmission processing of the data transmission server is delegated to the data retransmission server, thereby making it possible to determine a data transmission schedule of the data transmission server without extending this schedule, and therefore a user can easily acquire a transmission beginning time of data. Moreover, the load of data transmission processing can be distributed in the entire system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a data transmission system of an embodiment according to the present invention.

FIG. 2 is a block diagram of another form of the data transmission system of the embodiment according to the present invention.

FIG. 3 is a block diagram showing a structure of a data transmission control server.

FIG. 4 is a block diagram showing functions of the data transmission control server.

FIG. 5 is a block diagram showing a structure of a data transmission server.

FIG. 6 is a block diagram showing functions of the data transmission server.

FIG. 7 is a block diagram showing a structure of a data retransmission server.

FIG. 8 is a block diagram showing functions of the data retransmission server.

FIG. 9 is a block diagram showing a structure of a client.

FIG. 10 is a block diagram showing functions of the client.

FIG. 11 is a time sequence diagram showing the whole data transmission processing.

FIG. 12 is a time sequence diagram when the data transmission server receives a data retransmission request from the client in a data transmission processing.

FIG. 13 is a time sequence diagram when the data transmission control server receives a data retransmission request from the client in the data transmission processing.

FIG. 14 is a time sequence diagram showing a data transmission termination process.

FIG. 15 is a time sequence diagram when the data retransmission server receives a data reception completion notification from the client in the data transmission termination process.

FIG. 16 is a time sequence diagram when the data transmission control server receives data reception completion notifications from clients in the data transmission termination process.

FIG. 17 is a time sequence diagram showing a data transmission rate adjusting process.

FIG. 18 is a flowchart showing an example of the control of the data transmission control server.

FIG. 19 is a flowchart showing an example of the control of the data transmission server.

FIG. 20 is a flowchart showing an example of the control of the data retransmission server.

FIG. 21 is a flowchart showing an example of the control of the client.

FIG. 22 is an explanatory view showing an example of packets used in the data transmission system.

### DESCRIPTION OF THE EMBODIMENTS

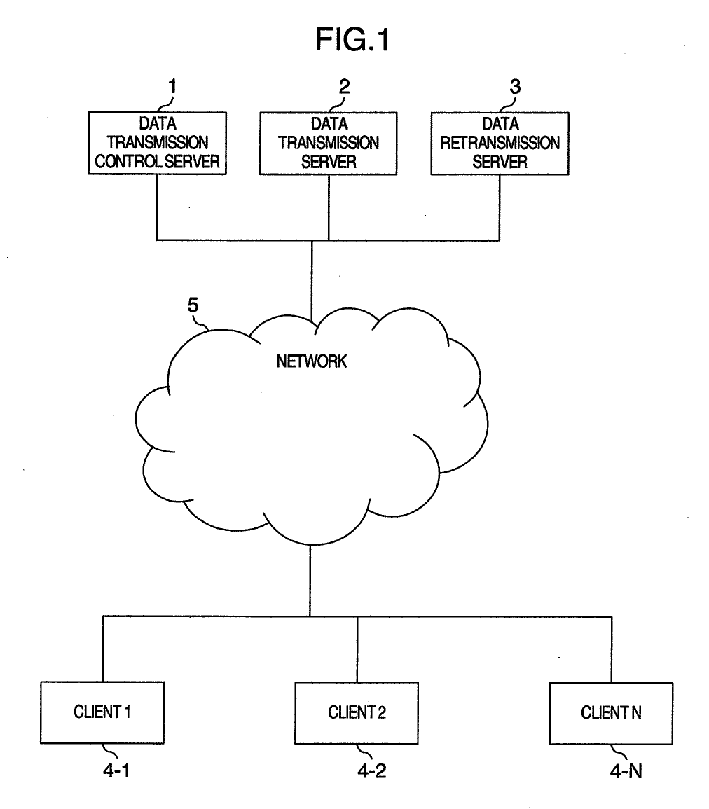

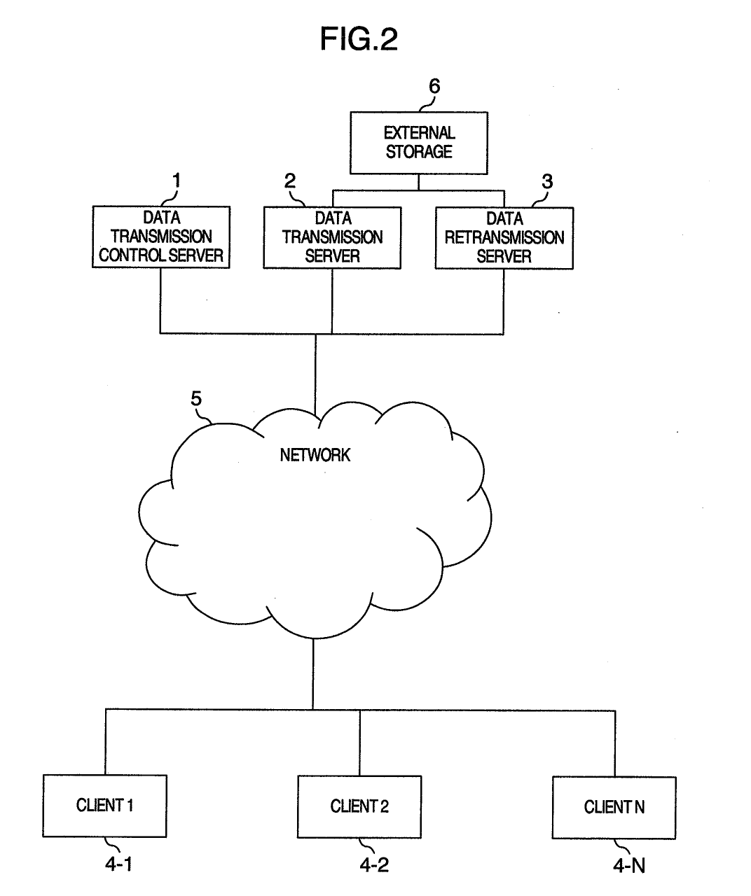

Hereinafter, an embodiment of the present invention is described according to the accompanying drawings. FIG. 1 shows an example employing a system according to the present invention, showing a structural diagram of a data transmission system including: a data transmission control server 1 connected via a network 5 and managing a transmission schedule of large-volume data transmission; a data transmission server 2 that only once performs data transmission to a plurality of users by using reliable multicast communication; a data retransmission server 3 that performs a retransmission processing of data based on a data retransmission request from a user; and a plurality of clients (4-1 to 4-N) for storing transmission data in a hard disk and providing this data to a user. Moreover, the arrangements of data in the respective servers include various systems, for example, in FIG. 1, such as a system wherein the data transmission server 2 and the data retransmission server 3 respectively hold data, and a system wherein when transmitting data, the data is copied from the data transmission server 2 to the data retransmission server 3. Moreover, there is also a system using an external storage 6 as shown in FIG. 2.

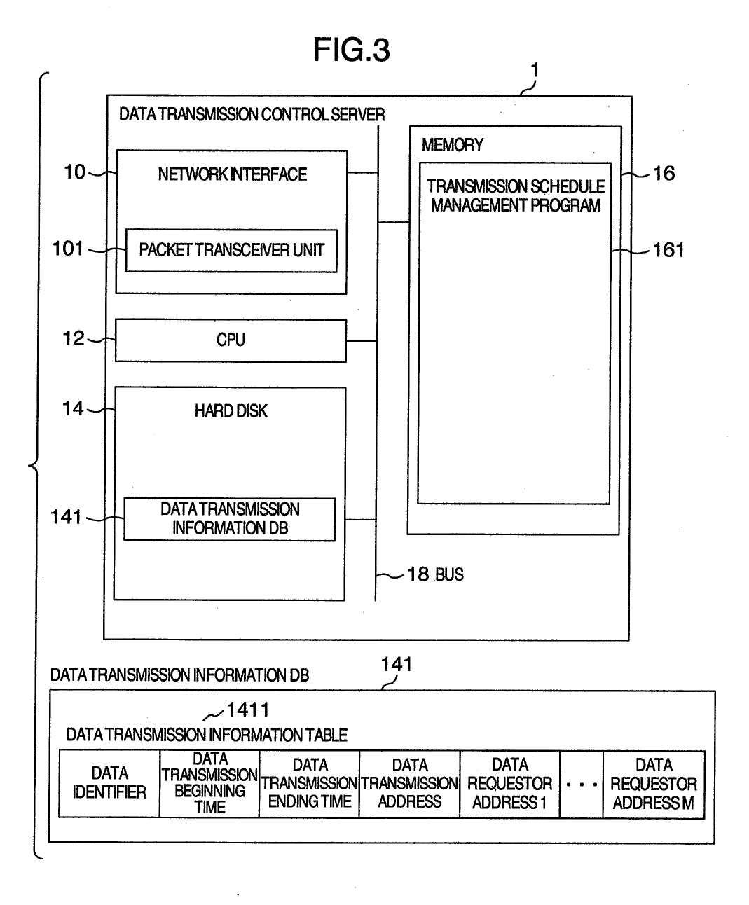

Next, each apparatus will be describes in detail. FIG. 3 shows an apparatus structure of the data transmission control server 1. The data transmission control server 1 includes a CPU 12, a memory 16, a hard disk 14, and a network interface 10 connected to a bus 18, and communicates with the network 5 via a packet transceiver unit 101 of the network interface 10. The hard disk 14 stores therein a data transmission information database (DB) 141 for storing information on the data transmission related to a transmission beginning time of data, a transmission ending time of data, and a data transmission address, and the like. Here, the read/write operation thereof is performed through a data transmission program 161 installed in the memory 16.

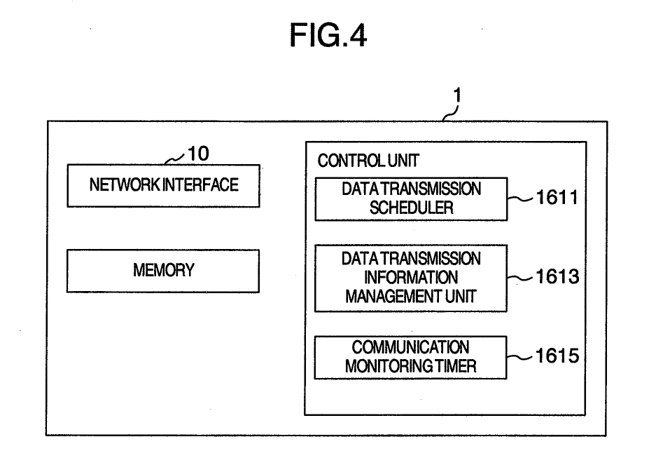

Access to the transmission schedule management program 161 stored in the memory 16 by the CPU 12 allows to include a control function of the present invention. FIG. 4 is a block diagram showing functions of the data transmission control server. The data transmission control server 1 includes the network interface 10, the memory for storing data transmission information and a transmission schedule management program, and a control unit. The control unit includes: a data transmission scheduler 1611 for managing a data transmission schedule of the transmission beginning time and ending time of data; a data transmission information management unit 1613 that manages data transmission information, acquires the transmission beginning time and ending time of data from the data transmission information DB 141, and notifies the data to the data transmission server 2 and the data retransmission server 3; and a communication monitoring timer 1615 that monitors communication sessions among the data transmission control server 1, the data transmission server 2, the data retransmission server 3, and the client 4, and detects an error thereof.

The data transmission information DB 141 includes a data transmission information table 1411. Each record of the data transmission information table 1411 includes a data identifier for uniquely determining data, a data transmission beginning time, a data transmission ending time, a data transmission address of a multicast address used in data transmission, and an address list (data requester address 1 to data requester address M) for storing data requesters. These pieces of information are used when the data transmission control server 1 controls the data transmission server 2 and the data retransmission server 3.

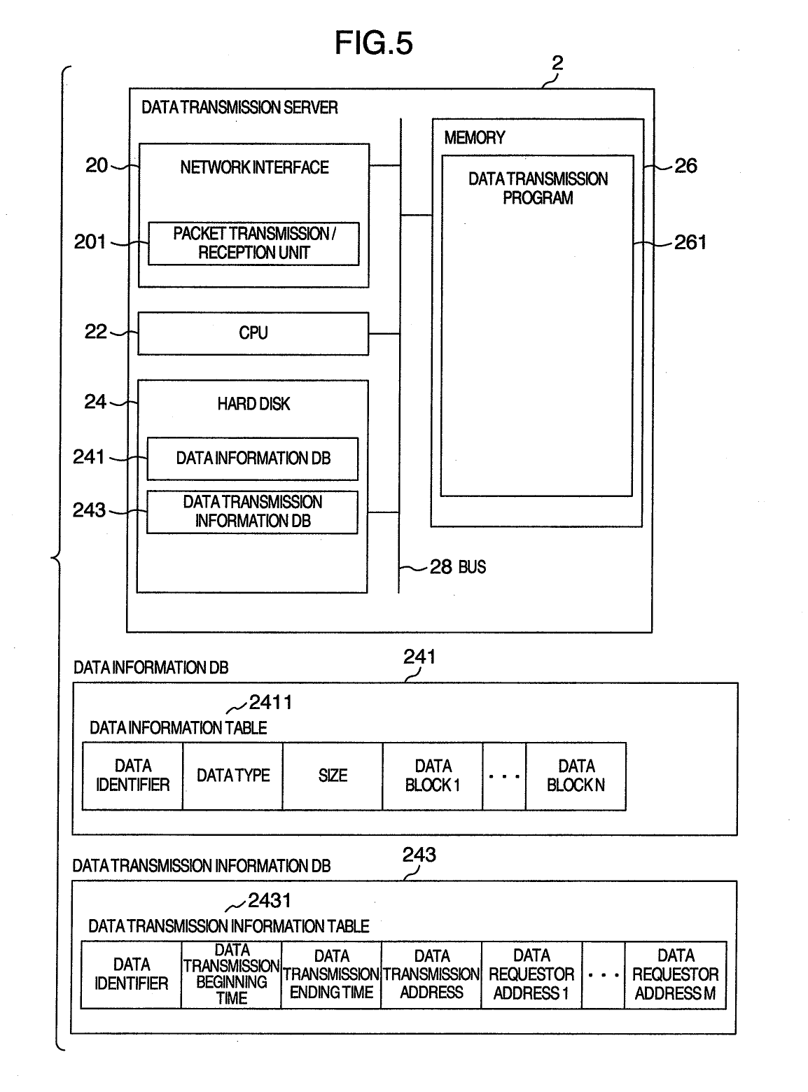

FIG. 5 shows an apparatus structure of the data transmission server 2. The data transmission server 2 includes a CPU 22, a memory 26, a hard disk 24, and a network interface 20 connected to a bus 28, and communicates with the network 5 via a packet transmission/reception unit 201 of the network interface 20. The hard disk 24 has stored therein a data information DB 241 related to the information on data that is transmitted based on a transmission schedule of the data transmission control server 1, and a data transmission information DB 243 for storing a data transmission scale notified from the data transmission control server 1. Here, the read/write operation thereof is performed through a data transmission program 261 installed in the memory 26.

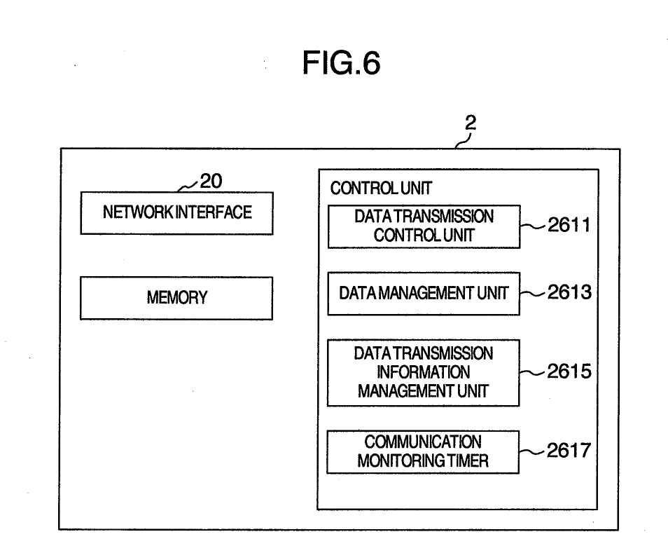

FIG. 6 is a block diagram showing functions of the data transmission server 2. The data transmission server 2 includes the network interface 20, the memory for storing the above-described data information, data transmission information, and transmission schedule management program, and a control unit. The control unit includes: a data transmission control unit 2611 having main functions of the data transmission program 261 on the memory 26; a data management unit 2613 for controlling the data information DB 241; a data transmission information management unit 2615 for controlling the data transmission information DB 243; and a communication monitoring timer 2617 that monitors communication sessions among the data transmission server 2, the data transmission control server 1, the data retransmission server 3, and the client 4, and detects an error. The data transmission control unit 2611 in association with the data management unit 2613 and the data transmission information management unit 2615 performs a data transmission processing through multicast communication.

Next, information managed by each of the databases is described as follows. The data information DB 241 includes a data information table 2411. Each record of the data information table 2411 stores therein a data identifier for uniquely determining a user, a data type indicative of the type of data, a data size indicative of the size of data, and the data. The data is managed in a divided state and each data block is determined by a block code. In FIG. 2, the data is managed as N blocks from a data block 1 to a data block N. The type of data may indicate information on an application of data, for example, such as voices, a motion image, or a program.

The data transmission information DB 243 includes a data transmission information table 2431. The structure of the data transmission information table 2431 is the same as that of the data transmission information table 1411 of the data transmission information DB 141 of the data transmission control server 1, so the description thereof is omitted.

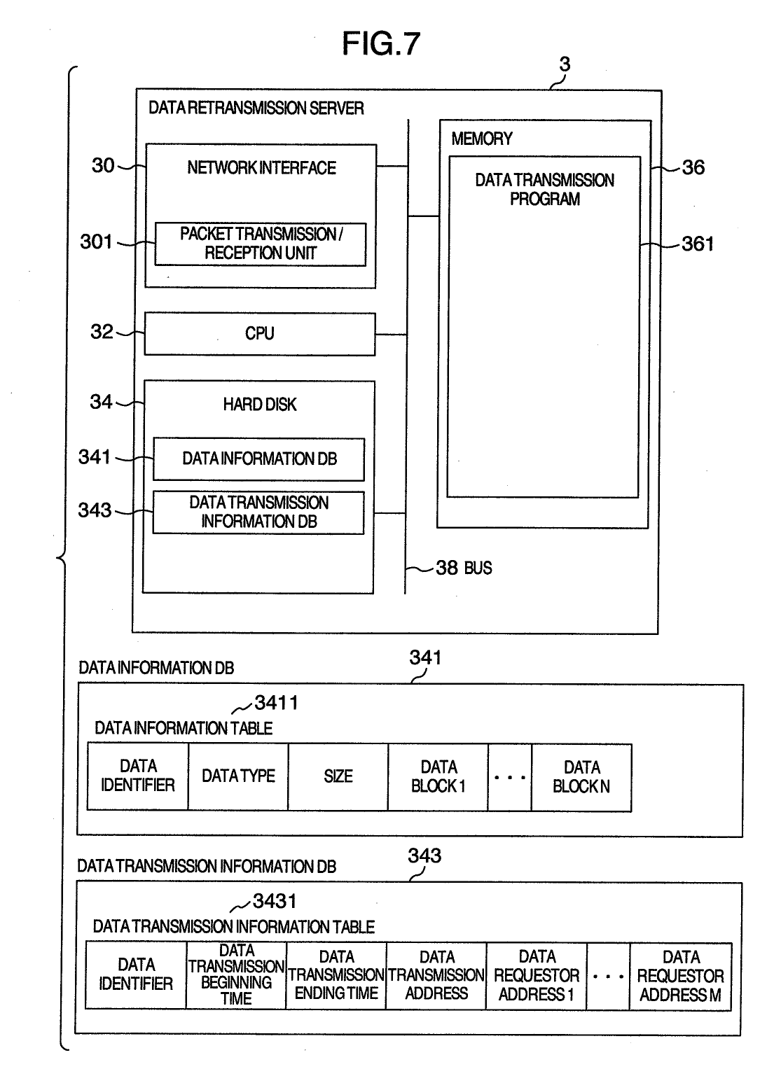

FIG. 7 shows a structure of the data retransmission server 3. The data retransmission server 3 includes a CPU 32, a memory 36, a hard disk 34, and a network interface 30 connected to a bus 38, and communicates with the network 5 via a packet transmission/reception unit 301 of the network interface 30. The hard disk 34 has stored therein a data information DB 341 for storing information related to the data that is transmitted based on a transmission schedule of the data transmission control server 1, and a data transmission information DB 343 for storing a data transmission schedule notified from the data transmission control server 1. Here, the read/write operation thereof is performed through a data transmission program 361 installed in the memory 36.

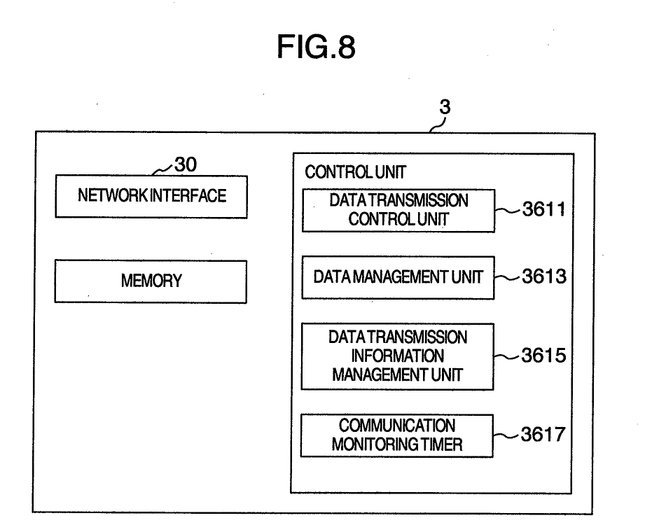

FIG. 8 is a block diagram showing functions of the data retransmission server 3. The data retransmission server 3 includes the network interface 30, the memory for storing the above-described data information, data transmission information, and transmission schedule management program, and a control unit. The control unit includes: a data transmission control unit 3611 having main functions of the data transmission program 361 on the memory 36; a data management unit 3613 for controlling the data information DB 341; a data transmission information management unit 3615 for controlling the data transmission information DB 343; and a communication monitoring timer 3617 that monitors communication sessions among the data retransmission server 3, the data transmission control server 1, the data transmission server 2, and the client 4, and detects an error thereof. The data transmission control unit 3611 in association with the data management unit 3613 and the data transmission information management unit 3615 performs a data transmission processing through multicast communication.

The data information DB 341 includes a data information table 3411, and the data transmission information DB 343 includes a data transmission information table 3431. The structure of the data information table 3411 and the structure of the data transmission information table 3431 are the same as that of the data information table 2411 of the data information DB 241 and that of the data transmission information table 2431 of the data transmission information DB 243, respectively, so the description thereof is omitted.

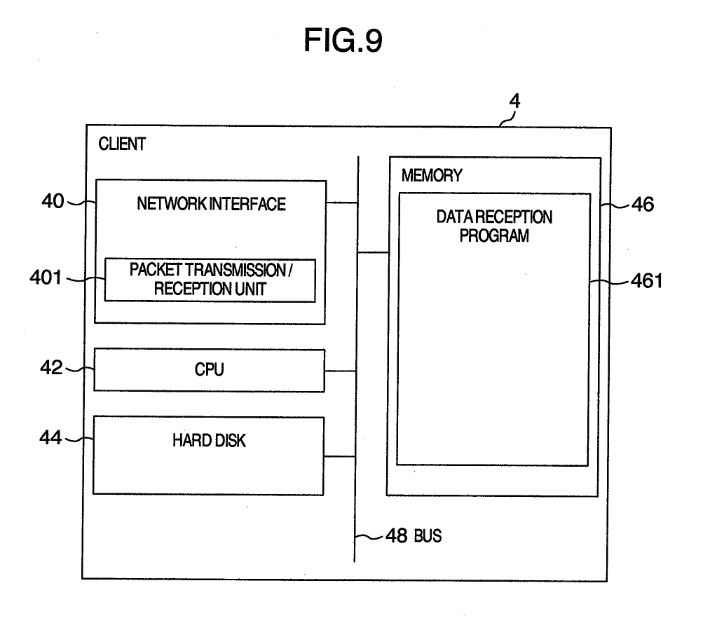

FIG. 9 shows an apparatus structure of the client 4. The client 4 includes a CPU 42, a memory 46, a hard disk 44, and a network interface 40 connected to a bus 48, and communicates with the network 5 via a packet transmission/reception unit 401 of the network interface 40.

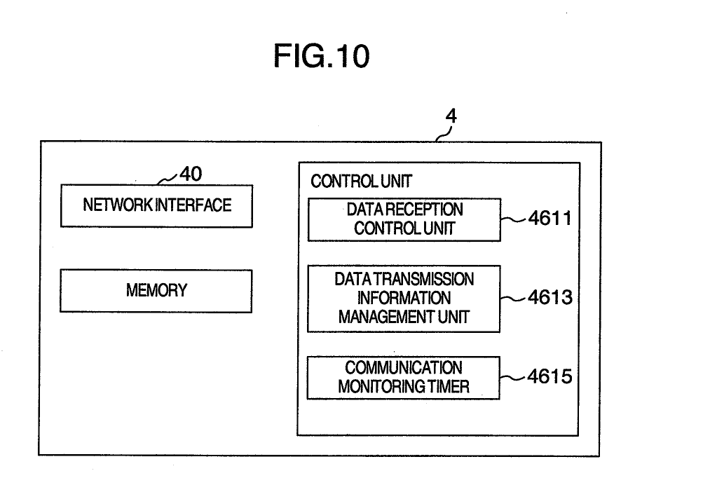

FIG. 10 is a block diagram showing functions of the client 4. The client 4 includes the network interface 40, the memory for storing received data and a data reception program, and a control unit. The control unit includes: a data reception control unit 4611 having main functions of a data reception program 461 on the memory 46; a data transmission information management unit 4613 for managing data transmission information corresponding to a client request; and a communication monitoring timer 4615 that monitors communication sessions among the client 4, the data transmission control server 1, the data retransmission server 2, and the data retransmission server 3, and detects an error. The data reception control unit 4611 in association with the data transmission information management unit 4613 performs a receiving processing of the data that is transmitted through multicast communication.

Next, the operation of the entire data transmission system publicized in the present invention is described with reference to time sequence diagrams.

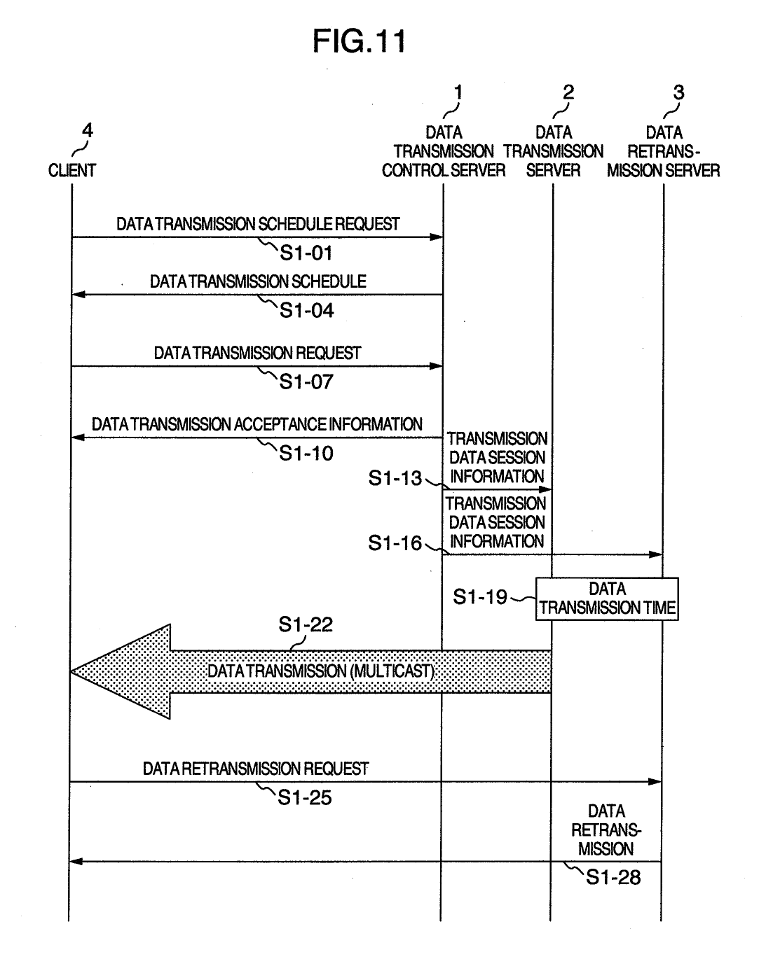

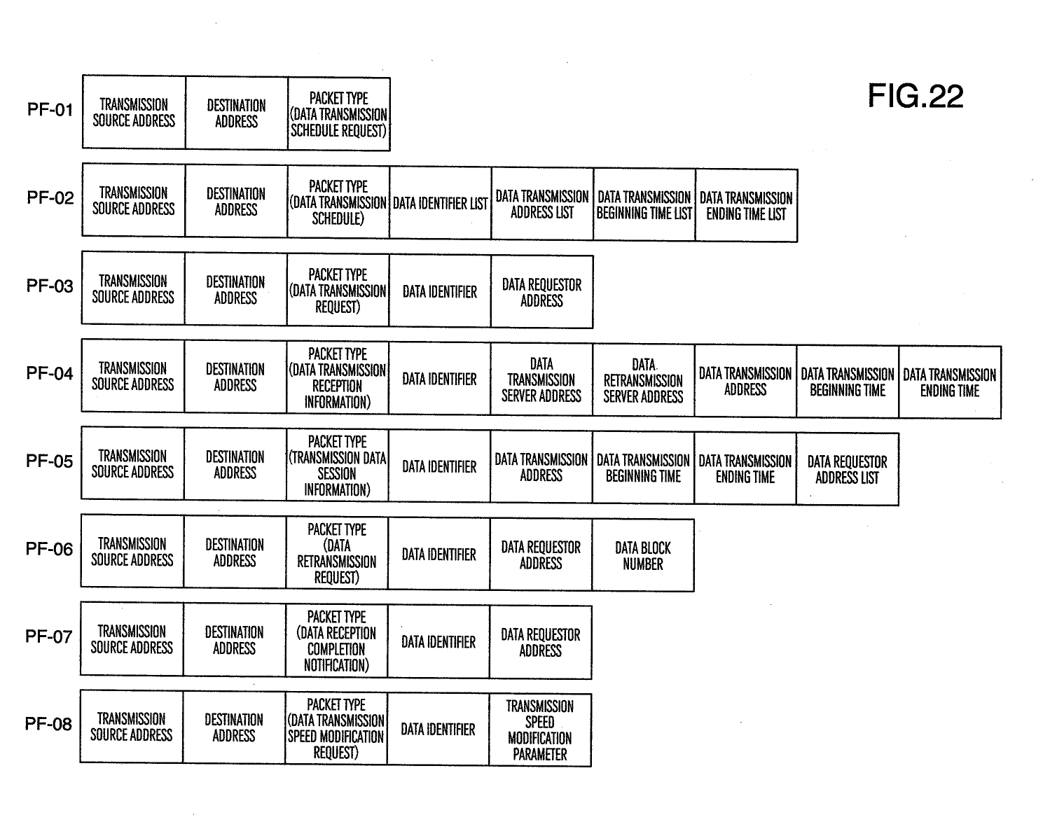

First, a basic operation in receiving data via the data transmission control server 1 of the client 4 is described using FIG. 11. The data transmission processing starts by transmitting a data transmission schedule request to the data transmission control server 1 via the client 4 (S1-01). FIG. 22 shows contents of the data transmission schedule request. Upon receipt of the data transmission schedule request transmitted from the client 4, the data transmission control server 1 searches the data transmission information DB 141 and acquires all of the data identifier, the data transmission beginning time, the data transmission ending time, and the data transmission address, thereby acquiring a data transmission schedule, and then transmits the data transmission schedule to the client 4 (S1-04).

Upon receipt of the data transmission schedule, the client 4 displays a list of data transmission schedules, and presents this list to a user for selection of data desired to be received. If the user selects data to be received, from the list of data transmission schedules, then the client 4 transmits a data transmission request to the data transmission control server 1 (S1-07).

Upon receipt of the data transmission request from the client 4, the data transmission control server 1 fetches the data identifier and the data requestor address from the data transmission request, and searches the data transmission information table 1411, with the data identifier as a keyword. If a record corresponding to the data identifier is present, the data transmission control server 1 adds the fetched data requester address to a data requester addresses of the corresponding record in the order from the beginning. Upon completion of update of the data transmission information DB 141, the data transmission control server 1 transmits data transmission acceptance information to the client 4 (S1-10).

Upon completion of the notification of the data transmission information to the client 4, the data transmission control server 1 transmits transmission data session information to the data transmission server 2 and the data retransmission server 3 that transmit data (S1-13, S1-16).

Upon receipt of the transmission data session information, the data transmission server 2 fetches the data identifier, the data transmission address, the data transmission beginning time, the data transmission ending time, and the data requestor address list from the transmission data session information, and stores the respective information into a corresponding field of the data transmission information table 2431. The data retransmission server 3 also performs the same processing and updates the data transmission information table 3431. However, since the data transmission ending time included in the transmission data session information is a time to finish data transmission of the data transmission server 2, the data retransmission server 3 adds a time of the retransmission monitoring timer, which the server has as a predetermined value, to the above-described data transmission ending time and regards the resultant time as the final data transmission ending time, and stores this in the data transmission information table 3431. The preparation of the data transmission processing is complete through the above processings.

When the data transmission time has come (S1-19), the data transmission server 2 starts to transmit data based on the data transmission address of the data transmission information table 2411, and the data retransmission server 3 starts preparation for processing a data retransmission request from the client 4 (S1-22). Transmission of data is performed in reliable multicast communication, and if the client 4 detects a loss of data, the client 4 requests for retransmission of the data. In order to acquire the address of the data retransmission server 3 from the data transmission acceptance information received in Step S1-10, the client 4 transmits a data retransmission request to the data retransmission server 3 (S1-25).

Upon receipt of the data retransmission request from the client 4, the data retransmission server 3 acquires the data requester address and the data block number from the data retransmission request, and retransmits a data block corresponding to the data block number to the data transmission source. The data retransmission being performed by the data retransmission server 3 will be complete after the data transmission server 2 finished the transmission of data and also at a time when a period determined as a predetermined value by the retransmission monitoring timer, which the server has, has elapsed.

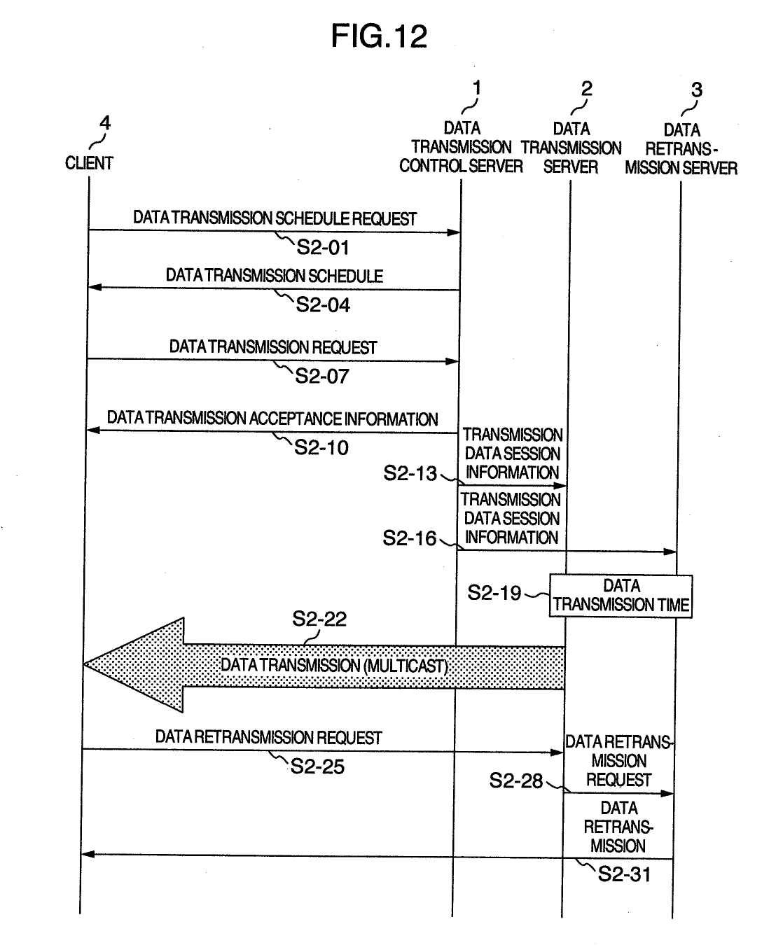

Next, the operation when a data retransmission request from the data transmission server is accepted is described using FIG. 12. Since the procedures from Step S2-01 to Step S2-07, in which the processings of a data transmission request by the client 4 of a user are performed, is the same as that of the processings from Step S1-01 to S1-07 in FIG. 7, the description thereof is omitted. Upon receipt of a data transmission request from the user, the data transmission control server 1 transmits data transmission acceptance information to the client 4. Here, the data transmission acceptance information has the address of the data transmission server 2 stored in both a data transmission server address and a data retransmission server address. By this processing, the address of the data retransmission server 3 is concealed when viewed from the user, and the data retransmission request is transmitted from the client 4 to the data transmission server 2 (S2-25). Upon receipt of the data retransmission request from the client 4, the data transmission server 2 transmits the data retransmission request to the data retransmission server 3 (S2-28), but the data transmission server 2 itself will not perform the data retransmission processing. Upon receipt of the data retransmission request from the data transmission server 2, the data retransmission server 3 performs the data retransmission processing through the same procedure as that of Step S1-28 of FIG. 11 (S2-31). The processings of the procedure from Step S2-13 to Step S2-22, the description of which is omitted in FIG. 12, are the same as those of the procedure from Step S1-13 to Step S1-22 of FIG. 11.

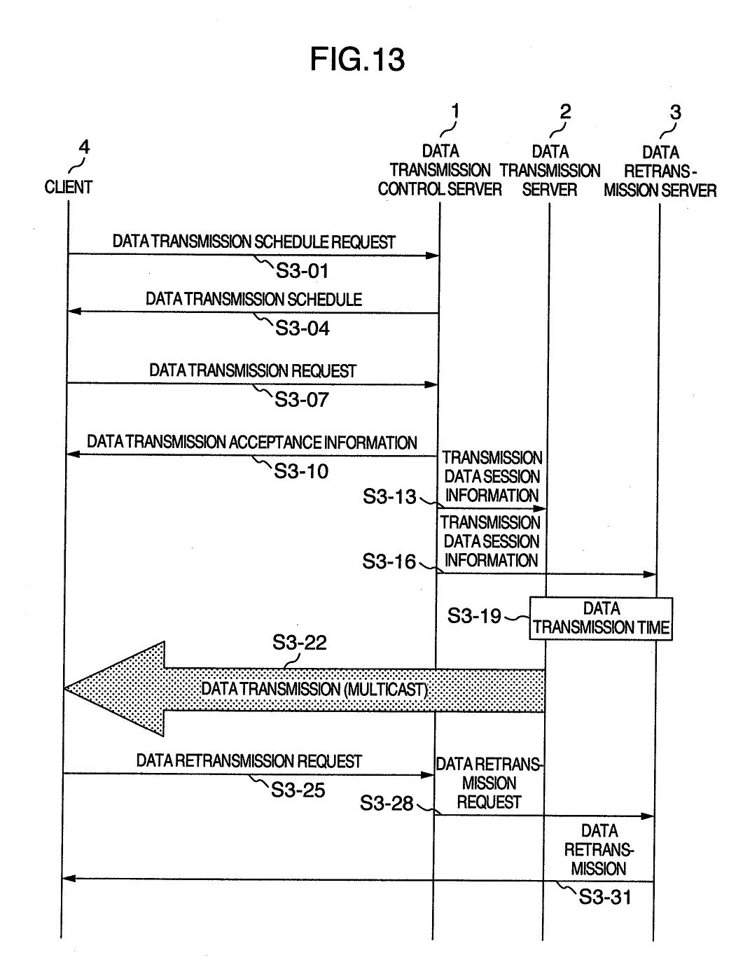

Moreover, as shown in FIG. 13, consider how a data retransmission request from the data transmission control server 1 is processed. Since the procedure from Step S3-01 to Step S3-07, in which the processings of a data transmission request by the client 4 of a user are performed, is the same as that of the processings from Step S1-01 to S1-07 in FIG. 11, the description thereof is omitted. Upon receipt of a data transmission request from the user, the data transmission control server 1 transmits data transmission acceptance information to the client 4. Here, the data transmission acceptance information has the address of the data transmission server 2 stored in the data transmission server address, and has the address of the data transmission control server 1 stored in the data retransmission server address. By this processing, the address of the data retransmission server 3 is concealed when viewed from the user, and the data retransmission request is transmitted from the client 4 to the data transmission control server 1 (S3-25). Upon receipt of the data retransmission request from the client 4, the data transmission control server 1 transmits the data retransmission request to the data retransmission server 3 (S3-28), but the data transmission server 1 itself will not perform the data retransmission processing. Upon receipt of the data retransmission request from the data transmission control server 1, the data retransmission server 3 performs the data retransmission processing through the same procedure as that of Step S1-28 of FIG. 11 (S3-31). The processings of the procedure from Step S3-13 to Step S3-22, the description of which is omitted in FIG. 12, are the same as those of the procedure from Step S1-13 to Step S1-22 of FIG. 11.

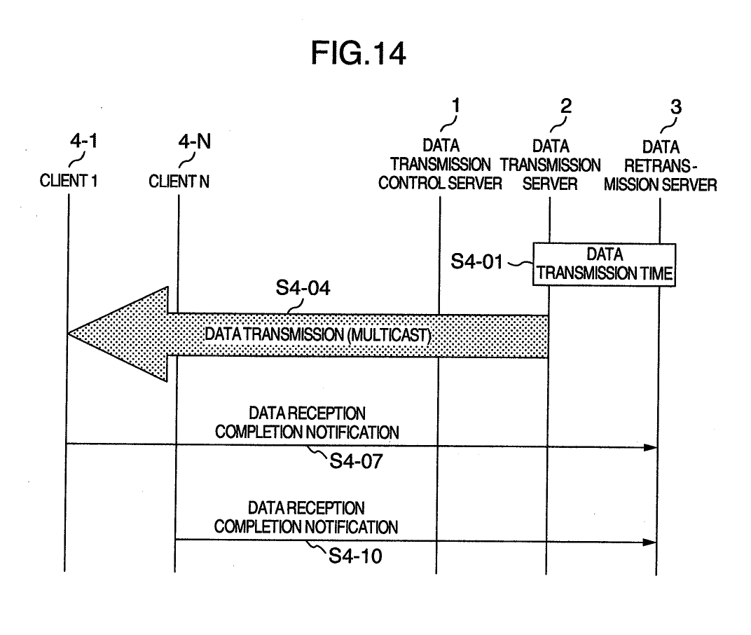

Next, a termination procedure of the data retransmission processing is described using FIG. 14. The data specified after going through the procedure from Step S1-01 to Step S1-16 of FIG. 11 is simultaneously transmitted to a plurality of clients by multicast communication (S4-01, 04), and the client 4 stores the data sequentially in the memory, and after receiving all the data, the client 4 transmits a data reception completion notification to the server. Here shows, as an example, a processing in which the client 1 (4-1) transmits the data reception completion notification to the data retransmission server 3 (S4-07).

FIG. 22 shows the contents of the data reception completion notification. A data reception completion notification PF-07 includes a transmission source address, a destination address, a packet type, a data identifier, and a data requester address. Transmission of the data reception completion notification is performed to each user, and upon completion of data reception, the client 4 transmits a completion notification to the data retransmission server 3 each time (S4-10). Upon receipt of the data reception completion notifications from all the users included in the data transmission information database 343, the data retransmission server 3 stops the data retransmission processing. The transmission destination of the data reception completion notification varies with the address of a server, which is specified as the data retransmission server address when the data transmission control server 1 transmits data transmission acceptance information to the client 4 (S1-10 of FIG. 11, S2-10 of FIG. 12, and the like). In FIG. 12, the data transmission server 2 is specified in the data retransmission server address. Accordingly, the data reception completion notification from the client 4 is transmitted to the data transmission server 2 (S5-07, 13), and the data transmission server 2 transmits the received message to the data retransmission server 3 (S5-10, 16). The processings other than the message relay processing performed by the data transmission server 2 are the same as those of FIG. 14.

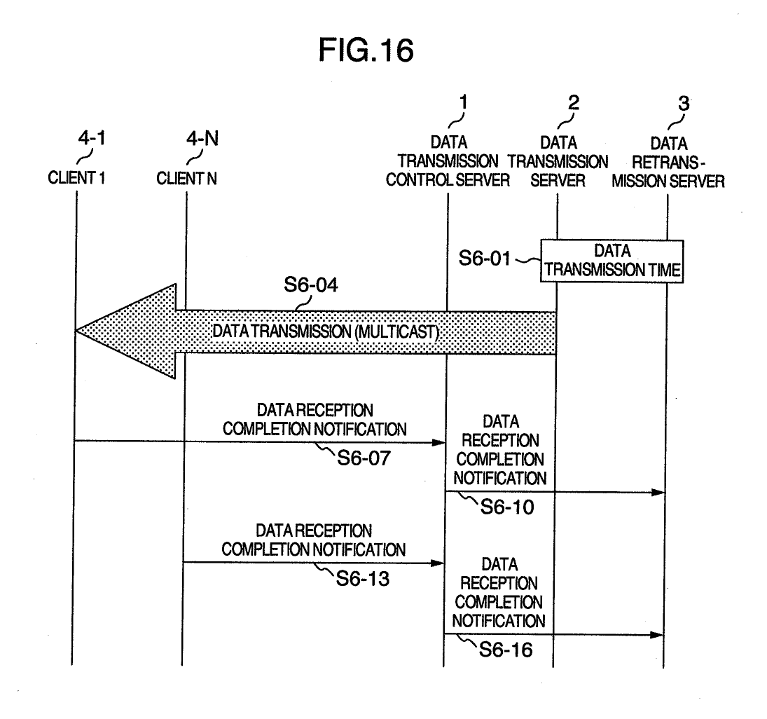

In FIG. 13, the data transmission control server 1 is specified in the data retransmission server address, so the relay processing of the data reception completion is performed by the data transmission control server (S6-10, 16) as shown in FIG. 16.

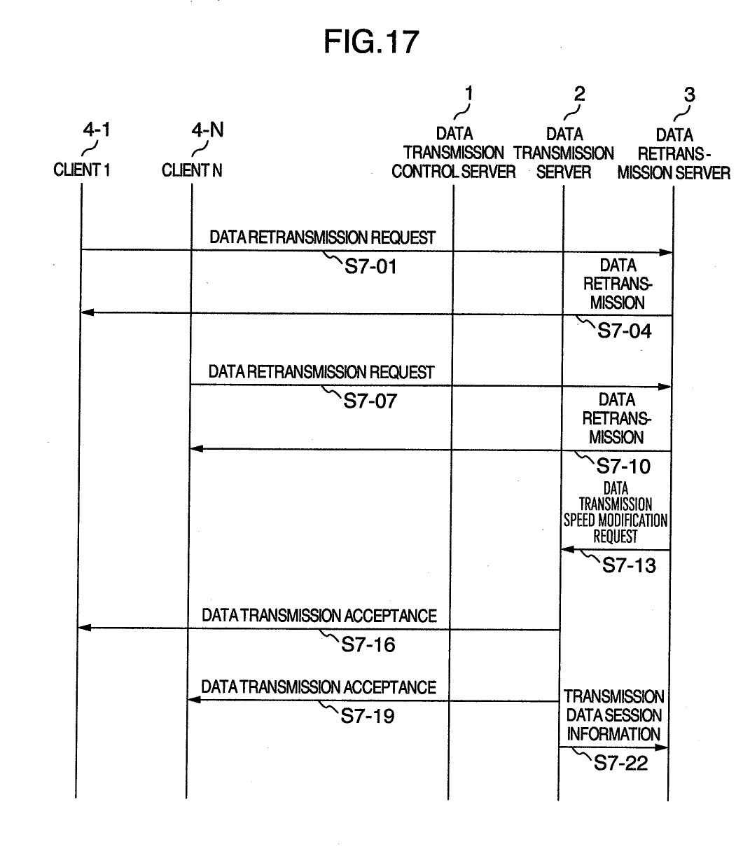

A failure may occur in the network during data transmission and cause a trouble in data reception at a client. FIG. 17 shows processings when data retransmission requests from clients concentrate. Here, although a case is described where messages are directly transmitted to the data retransmission server 3, the basic operation is also the same when the data transmission server 2 or the data transmission control server 1 performs the message relay processing.

Upon detection of a loss of data, the client 4-1 transmits a data retransmission request to the data retransmission server 3 (S7-01). The data retransmission server 3 retransmits the requested data to the client 4-1 (S7-04). Here, if a plurality of clients cannot receive the same data due to a failure, other clients (e.g., N clients) request for retransmission of the same data (S7-07). After retransmitting the requested data (S7-10), the data retransmission server 3 determines whether or not the number of clients requested for retransmission of the data exceeds a threshold value defined by the system. The threshold value here is defined as a ratio of the users requested for data transmission of all the users. If the number of clients having requested for retransmission of the data exceeds the threshold value, the data retransmission server 3 determines that the data transmission rate is too fast for the data to reach a plurality of clients, and transmits a data transmission speed modification request to the data transmission server 2 (S7-13). FIG. 22 shows the contents of the data transmission speed modification request. A data transmission speed modification request PF-08 includes a transmission source address, a destination address, a packet type, a data identifier, and a transmission speed modification parameter. The transmission speed modification parameter includes information on how to change the transmission speed, for example, such as a weighting factor for reducing the transmission speed or an absolute value of the transmission speed. The weighting factor takes a value between 0 and 1, and upon receipt of the weighting factor, the data transmission server 2 adjusts the speed, and sets a transmission speed obtained by multiplying the current transmission speed by the weighting factor, to a new transmission speed. Upon receipt of an absolute value of the transmission speed, the data transmission server 2 just specifies the transmission speed to this value. For example, if a speed such as 2 Mbps is specified, the data transmission server 2 sets the transmission speed to this value. Upon receipt of a data transmission speed modification request, the data transmission server 2 adjusts the data transmission rate based on the transmission speed modification parameter in the message, and recalculates the data transmission ending time. Recalculation of the data transmission ending time is performed based on the data size and the data transmission rate, for example. Subsequently, the data transmission information including the data transmission ending time that is recalculated by utilizing the data transmission acceptance message is notified to all the clients currently receiving the data (S7-16, 19). Moreover, the transmission data session information is transmitted to the data retransmission server 3 (S7-22) to update the information of the data retransmission server. Modification of the data transmission rate is complete through the above processings.

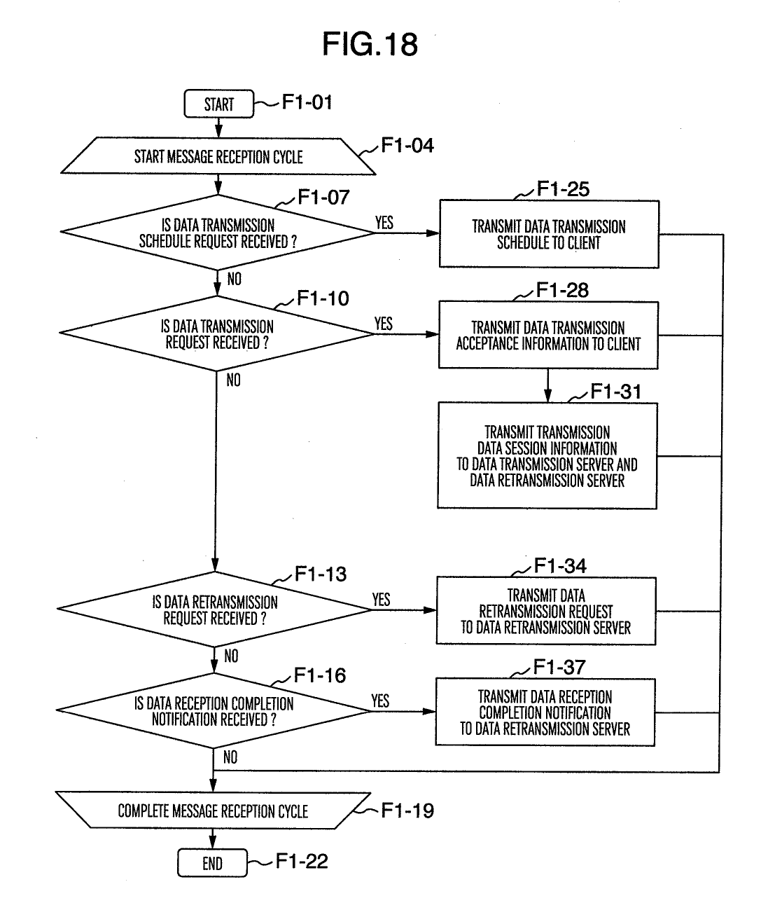

An example of the control performed by the data transmission control server 1 is described with reference to a flowchart of FIG. 18. This flowchart is executed at a predetermined cycle. After turning on power (Step F1-01), the data transmission control server 1 starts a message reception cycle (Step F1-04) and receives a message from the network 5. In Step F1-07, it is determined whether or not the received message is a data transmission schedule request from a client, and if it is the data transmission schedule request, the flow proceeds to Step F1-25 and a data transmission schedule is transmitted to the client 4 (S1-04 etc. of FIG. 11). On the other hand, if the received message is not the data transmission schedule request, the flow proceeds to Step F1-10 and it is determined whether or not the message is a data transmission request from the client 4. If it is the data transmission request, the flow proceed to Step F1-28 and data transmission acceptance information is transmitted to the client 4 (S1-10 etc. of FIG. 11), and in Step F1-31 transmission data session information is transmitted to the data transmission server 2 and the data retransmission server 3, respectively (S1-13 etc. of FIG. 11).

If the received message is not the data transmission request, the flow proceeds to Step F1-13 and it is determined whether or not the message is a data retransmission request from a client. If the message is the data retransmission request, the flow proceeds to Step F1-34 and the received message is transmitted to the data retransmission server 3. If the received message is not the data retransmission request, the flow proceeds to Step F1-16 and it is determined whether or not the message is a data reception completion notification from the client 4. If the message is the data reception completion notification, the flow proceeds to Step F1-37 and the received data is transmitted to the data retransmission server 3. The message reception cycle is complete (Step F1-19) after turning off a power supply of the data transmission control server 1 (Step F1-22). Through the above processings, the data transmission control server 1 controls the data transmission server 2 and the data retransmission server 3 based on the request from the client 4.

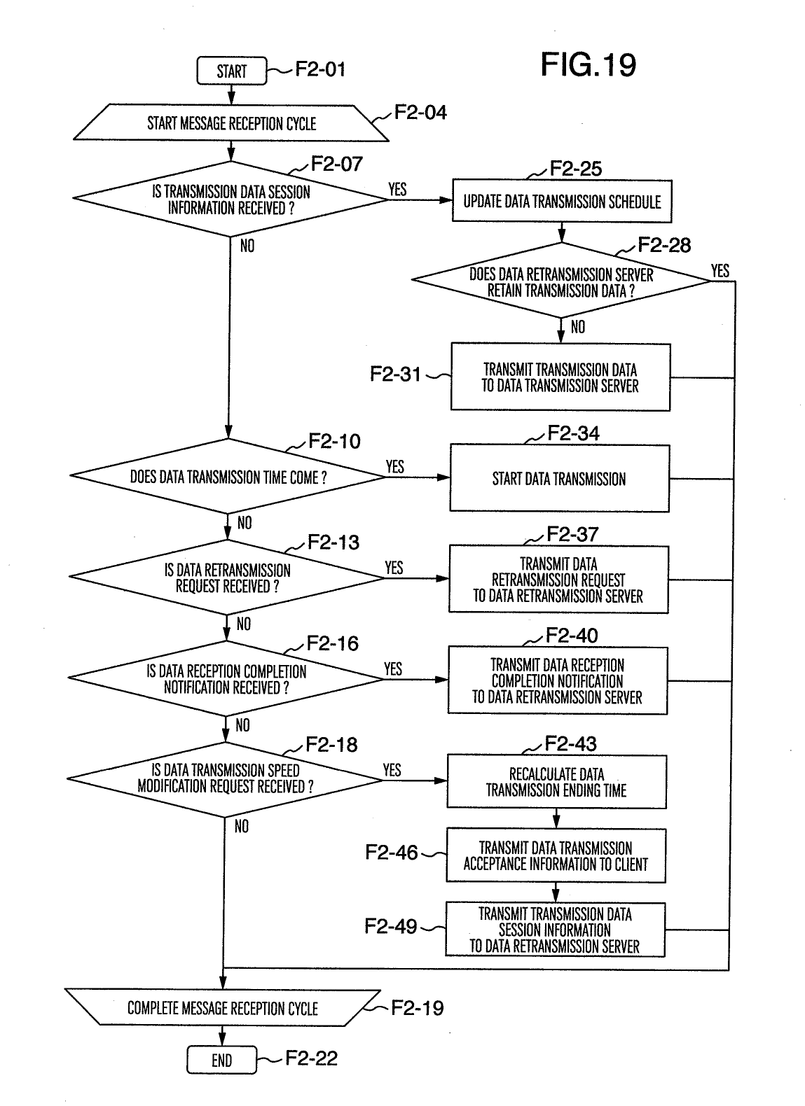

Next, an example of the control performed by the data transmission server 2 is described with reference to a flowchart of FIG. 19. This flowchart is executed at a predetermined cycle. After turning on power (Step F2-01), the data transmission server 2 starts a message reception cycle (Step F2-04) and receives a message from the network 5. In Step F2-07, it is determined whether or not the received message is transmission data session information from the data transmission control server 1, and if it is the transmission data session information, the flow proceeds to Step F2-25 and the data transmission schedule is updated (S1-13 etc. of FIG. 11). Next, the flow proceeds to Step F2-28 and it is confirmed whether or not there is any data to transmit to the data retransmission server 3. This confirmation is not required in a system structure in which the data retransmission server 3 of FIG. 1 always retains a copy of transmission data, and in a structure in which the data transmission server 2 and the data retransmission server 3 share an external storage as shown in FIG. 2. In FIG. 1, if the data retransmission server 3 retains a copy of transmission data only at the time of data retransmission processing, it is determined whether or not the data transmission server 2 already transmits the data to the data retransmission server 3, and if there is no transmission data, the flow proceeds to Step F2-31 and the data is transmitted to the data retransmission server 3 to prepare data transmission.

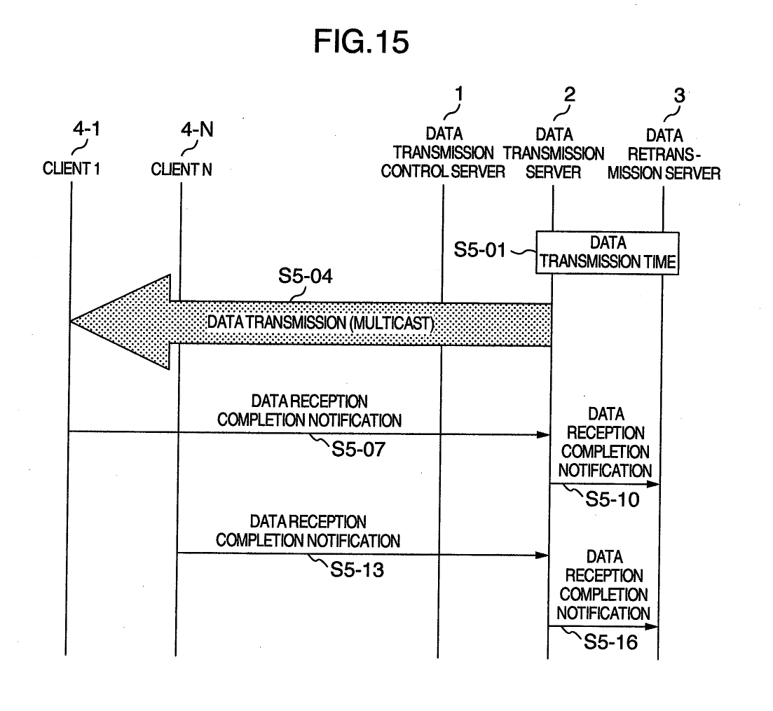

On the other hand, if the received message is not the transmission data session information, the flow proceeds to Step F2-10 and it is determined whether or not the time becomes a delivery time of data determined by a certain data identifier. If the time becomes the delivery time of data, the flow proceeds to Step F2-34 and the transmission of data determined by the data identifier is started (S1-22 etc. of FIG. 11). If the time does not become the delivery time of data, the flow proceeds to Step F2-13 and it is determined whether or not the received message is a data retransmission request from the client 4. If the message is the data retransmission request, the flow proceeds to Step F2-37 and a received-data retransmission request is transmitted to the data retransmission server (S2-28 of FIG. 12). If the received message is not the data retransmission request in Step F2-13, the flow proceeds to Step F2-16 and it is determined whether or not the message is a data reception completion notification from the client 4. If the message is the data reception completion notification, the flow proceeds to Step F2-40 and the data reception completion notice is transmitted to the data retransmission server (S5-16 of FIG. 15). If the received message is not the data reception completion notification, the flow proceeds to Step F2-18 and it is determined whether or not the message is a data transmission speed modification request. If the message is the data transmission speed modification request, the flow proceeds to Step F2-43 and the data transmission ending time is recalculated. Subsequently, in Step F2-46, the data transmission acceptance information is transmitted to the client 4, and the recalculated data transmission ending time is notified to the client 4. Next, the flow proceeds to Step F2-29 and transmission data session information is transmitted to the data retransmission server 3, and the recalculated data transmission ending time is notified to the data retransmission server 3. The message reception cycle is complete (Step F2-19) after turning off a power supply of the data transmission server 2 (Step F2-22). Through the above processings, the data transmission server 2 performs the transmission processing of data based on the request from the client 4 and under the control of the data transmission control server 1.

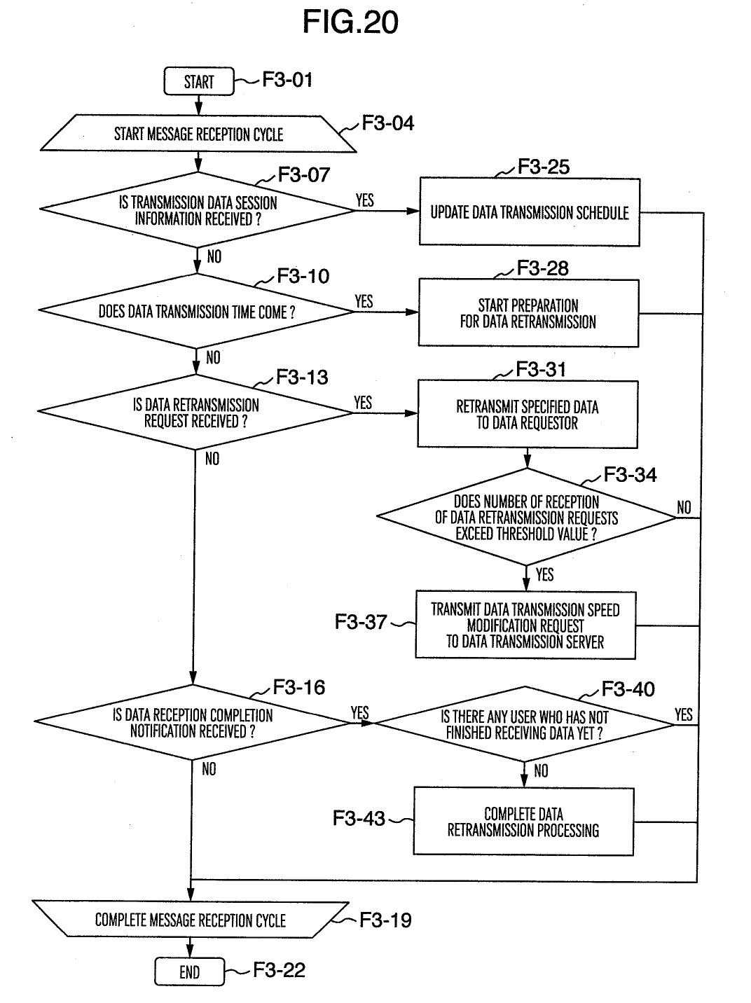

Next, an example of the control performed by the data retransmission server 3 is described with reference to a flowchart of FIG. 20. This flowchart is executed at a predetermined cycle. After turning on power (Step F3-01), the data retransmission server 3 starts a message reception cycle (Step F3-04) and receives a message from the network 5. In Step F3-07, it is determined whether or not the received message is transmission data session information from the data transmission control server 1, and if it is the transmission data session information, the flow proceeds to Step F3-25 and the data transmission schedule is updated (S1-16 etc. of FIG. 11). On the other hand, if the received message is not the transmission data session information, the flow proceeds to Step F3-10 and it is determined whether or not the time becomes the delivery time of data determined by a certain data identifier. If the time becomes the delivery time of data, the flow proceeds to Step F3-28 and preparation for the retransmission of data determined by the data identifier is started (S1-19 etc. of FIG. 11). If the time does not become the delivery time of data, the flow proceeds to Step F3-13 and it is determined whether or not the received message is a data retransmission request. If the message is the data retransmission request, the flow proceeds to Step F3-31 and a specified data block is retransmitted to a data transmission source (S1-28 etc. of FIG. 11).

Next, in Step F3-34, it is determined whether or not the number of reception of the data retransmission requests exceeds a specified threshold value. If it exceeds the threshold value, a data transmission speed modification request is transmitted to the data transmission server 2 (F3-37) to adjust the data transmission rate. In Step F3-13, if the received message is not the data retransmission request, the flow proceeds to Step F3-16 and it is determined whether or not the message is a data reception completion notification. If the message is the data reception completion notification, the flow proceeds to Step F3-40 and it is determined whether or not all the users have completed data reception. If all the users have completed data reception, the flow proceeds to Step F3-43 and the data retransmission processing is complete. The message reception cycle is complete (Step F3-19) after turning off a power supply of the data retransmission server 3 (Step F3-22). Through the above processings, the data retransmission server 3 performs the retransmission processing of data based on the request from the client 4 and under the control of the data transmission control server 1.

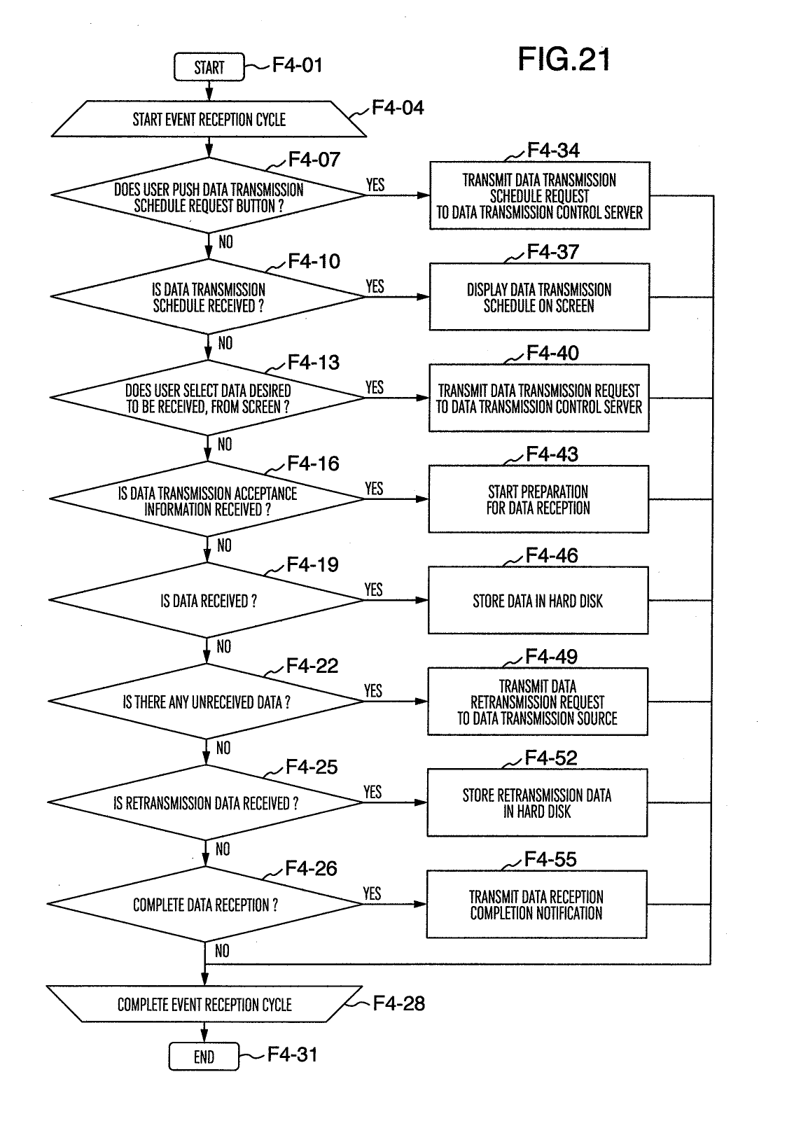

Next, an example of the control performed by the client 4 is described with reference to a flowchart of FIG. 21. This flowchart is executed at a predetermined cycle. After turning on power (Step F4-01), the client 4 starts an event reception cycle (Step F4-04), and receives a message from the network 5 and an event within a program generated by the operation of a user. In Step F4-07, it is determined whether or not the user has pushed a data transmission schedule request button of the client, and if the data transmission schedule request button has been pushed, the flow proceeds to Step F4-34 and a data transmission schedule request is transmitted to the data transmission control server 1 (S1-01 etc. of FIG. 11). On the other hand, if the data transmission schedule request button has not been pushed yet, the flow proceeds to Step F4-10 and it is determined whether or not the data transmission schedule has been received from the data transmission control server. If the data transmission schedule has been received, the flow proceeds to Step F4-37 and a list of data transmission schedules is displayed on a screen (S1-04 etc. of FIG. 11). If the data transmission schedule has not been received yet, the flow proceeds to Step F4-13 and it is determined whether or not the user has selected the data desired to be received, from the list of data transmission schedules displayed on the screen. If the user has selected the data desired to be received, the flow proceeds to Step F4-40 and a data transmission request including a specified identifier is transmitted to the data transmission control server 1 (S1-07 etc. of FIG. 11). If the user has not selected the data desired to be received yet, the flow proceeds to Step F4-16 and it is determined whether or not to start preparation for receiving data of the already transmitted data transmission request. If the preparation for receiving data is required, the flow proceeds to Step F4-43 and the required processing, such as reception by multicast communication, is performed. If the preparation for receiving data is not required, the flow proceeds to Step F4-19 and it is determined whether or not the data to be stored has been received. If the data has been received, the flow proceeds to Step F4-46 and the received data is stored in the hard disk. If the data to be stored has not arrived yet, the flow proceeds to Step F4-22 and it is determined whether or not there is any unreceived data block. If there is an unreceived data block, the flow proceeds to Step F4-49, and a data retransmission request specifying the unreceived data block number is transmitted to either of the data transmission control server 1, the data transmission server 2, and the data retransmission server 3, based on the structure of the system (S1-25 etc. of FIG. 11). If there is no unreceived data block, the flow proceeds to Step F4-52 and it is determined whether or not retransmission data has been received. If the retransmission data has been received, the retransmission data is stored in the hard disk as the data determined by the relevant data identifier. If the retransmission data has not been received yet, the flow proceeds to Step F4-26 and it is determined whether or not all the data have been received. If the data reception has been completed, the flow proceeds to Step F4-55. According to the structure of the system, a data reception completion notification is transmitted to either of the data transmission control server 1, the data transmission server 2, and the data retransmission server 3. The event reception cycle is complete (Step F4-28) after turning off a power supply of the data retransmission server 4 (Step F4-31). Through the above processings, the client 4 notifies the data transmission control server 1 of a data identifier desired to be received, thereby receiving the data and providing this data to the user.

FIG. 22 shows the contents of a data transmission schedule request PF-01. The data transmission schedule request PF-01 includes a transmission source address, a destination address, and a packet type.

FIG. 22 further shows the contents of a data transmission schedule PF-02. The data transmission schedule PF-02 includes a transmission source address, a destination address, a packet type, a data identifier list, a data transmission address list, a data transmission beginning time list, and a data transmission ending time list.

FIG. 22 further shows the contents of a data transmission request PF-03. The data transmission request PF-03 includes a transmission source address, a destination address, a packet type, a data identifier, and a data requester address list.

FIG. 22 further shows the contents of data transmission acceptance information PF-04. The data transmission acceptance information PF-04 includes a transmission source address, a destination address, a packet type, a data identifier, a data transmission server address, a data retransmission server address, a data transmission address, a data transmission beginning time, and a data transmission ending time. The data transmission server address and the data retransmission server address indicate the address of a data transmission source. The data transmission beginning time and the data transmission ending time respectively indicate a beginning time and ending time of the data transmission, which the data transmission server 2 performing transmission of data only once performs.

FIG. 22 further shows the contents of transmission data session information PF-05. The transmission data session information PF-05 includes a transmission source address, a destination address, a packet type, a data identifier, a data transmission address, a data transmission beginning time, a data transmission ending time, and a data requester address list. The data requester address list includes the addresses of all the clients requesting for transmission of the data that is determined by a relevant data identifier.

FIG. 22 further shows the contents of a data retransmission request PF-06. The data retransmission request PF-06 includes a transmission source address, a destination address, a packet type, a data identifier, a data requester address, and a data block number. The data block number indicates the block number of lost data.

As described above, the data transmission system according to the present invention is provided with a function to simultaneously and efficiently transmit large amounts of data to a plurality of unspecified users through multicast communication according to a predetermined transmission schedule by the data transmission control server, the data transmission server, the data retransmission server, and the client. It is therefore possible to use this system as a supplementary service of a broadcast type service such as IPTV.

It should be further understood by those skilled in the art that although the foregoing description has been made on embodiments of the invention, the invention is not limited thereto and various changes and modification may be made without departing from the spirit of the invention and the scope of the appended claims.

1. A data transmission control server, comprising:
a network interface connected to a network and communicating with a data transmission server, a data transmission auxiliary server, and a client via the network, wherein the data transmission server and the data transmission auxiliary server transmit data to the client based on a client request;
a data transmission information database having stored therein a data identifier for identifying transmission data, a data transmission address for specifying an address of the transmission data, and a data transmission beginning time indicative of a beginning time of data transmission; and
a control unit that controls the data transmission server and the data transmission auxiliary server so as to transmit data to the client by transmitting transmission data session information to the data transmission server and the data transmission auxiliary server based on a data transmission request from the client.

2. The data transmission control server according to claim 1, wherein when there is a loss in received data of the client, the data transmission auxiliary server retransmits data to the client based on a retransmission request from the client.

3. The data transmission control server according to claim 2, wherein the retransmission request from the client is directly transmitted to the data transmission auxiliary server, or is transmitted to the data transmission auxiliary server via the data transmission control server or the data transmission server.

4. The data transmission control server according to claim 2, wherein at a predetermined time, the data transmission server transmits data to the client using a multicast method, and the data transmission auxiliary server transmits data to the client using a unicast method.

5. The data transmission control server according to claim 1, wherein the data transmission control server transmits transmission data session information including the data identifier, the data transmission address, and the data transmission beginning time to the data transmission server and the data transmission auxiliary server via the network interface, so that the data transmission server and the data transmission auxiliary server transmit data to the client.

6. The data transmission control server according to claim 1, wherein a data transmission ending time indicative of a ending time of data transmission is further stored in the data transmission information database, and wherein the control unit controls the network interface so as to transmit transmission data session information including the data transmission ending time to the data transmission server.

7. The data transmission control server according to claim 1, wherein a data requester address for managing an address of a client having requested for data transmission is further stored in the data transmission information database, and wherein the control unit controls the network interface so as to transmit transmission data session information including the data requestor address to the data transmission auxiliary server.

8. The data transmission control server according to claim 1, wherein upon receipt of the data retransmission request from a plurality of the clients, the data transmission auxiliary server transmits a data transmission speed modification request to the data transmission server when the number of clients requesting for retransmission exceeds a predetermined threshold value.

9. The data transmission control server according to claim 8, wherein the predetermined threshold value is a ratio of clients requesting for data transmission of all the clients.

10. A data transmission auxiliary server, comprising:
a network interface connected to a network, the network interface communicating via the network with a client having requested for data transmission, a data transmission control server that controls a data transmission processing, and a data transmission server that transmits data at a predetermined time;
a data information database having stored therein transmission data including a data identifier for identifying the data transmission and a set of data blocks determined by a unique number;
a data transmission information database having stored therein a data identifier for identifying transmission data, a data transmission address for specifying an address of the transmission data, a data transmission beginning time indicative of a beginning time of the data transmission, and a data requestor address for managing an address of a client having requested for the data transmission; and
a control unit that receives transmission data session information from the data transmission control server, and retransmits data to the client, when there is a loss in the data received from the data transmission server and the client transmits a retransmission request.

11. A data transmission system, comprising:
a client; and
a data transmission control server, a data transmission server, and a data transmission auxiliary server that are connected to the client via a network,
wherein the data transmission server and the data transmission auxiliary server transmit data to the client under control of the data transmission control server,
wherein the data transmission control server is connected to the network and communicates with the data transmission server, the data transmission auxiliary server, and the client via the network, wherein the data transmission server and the data transmission auxiliary server respectively comprise: a network interface that transmits data to the client based on a client request; and a control unit with a data transmission information database having stored therein a data identifier for identifying transmission data, a data transmission address for specifying an address of the transmission data, and a data transmission beginning time indicative of a beginning time of data transmission, and
wherein by transmitting transmission data session information based on a data transmission request from the client, the control unit controls the data transmission server and the data transmission auxiliary server so as to transmit data to the client.
